(19) United States
(12) Patent Application Publication
(10) Pub. No.: US 2007/0168256 A1
(43) Pub. Date: Jul. 19, 2007

(54) Method and apparatus for marketing information to an individual using inquirey management

(76) Inventor: Stephen F. Horstmann, West Chester, PA (US)

Correspondence Address: Harding, Early, Follmer & Frailey;86 The Commons at Valley Forge East, 1288 Valley Forge Road, P.O. Box 750, Valley Forge, PA, 19482-0750, US

(21) Appl. No.: 11/724,430

(22) Filed: Mar. 15, 2007

Related U.S. Application Data
(63) Continuation-in-part of application No. 11/389,886, filed on Mar. 27, 2006, now abandoned.
(60) Provisional application No. 60/760,329, filed on Jan. 19, 2006.

(51) Int. Cl. G07G 1/14

(52) U.S. Cl. 705/14

(57) ABSTRACT

A method and apparatus for facilitating providing information to an individual using inquiry management, including providing a database of information which is associated to correspond with selections on a selection menu, a mechanism for input, collection and storage of user data, where selection data items may be associated with content information which may be used to generate a personalized web page which is associated with a personal uniform resource locator (PURL), where a PURL may be provided for each unique user and may be used to identify that unique user; and a media distribution engine for distributing electronic or printed media based on the user accesses of the user PURL.

### CROSS REFERENCE TO RELATED APPLICATIONS

This application is a continuation-in-part of, and claims priority to, U.S. patent application Ser. No. 11/389,886 filed on Mar. 27, 2006 which claims priority to U.S. provisional application Ser. No. 60/760,329 filed on Jan. 19, 2006, the disclosures of which are incorporated herein by reference.

### BACKGROUND OF THE INVENTION

1. Field of the Invention

The invention relates to a method and apparatus for marketing a brand to a target person, and more particularly to facilitate providing customized information for a particular individual recipient through personalized web pages and the delivery of other media.

2. Brief Description of the Related Art

For many years numerous sums of money have been spent on advertising, marketing and promotion to reach a particular target consumer or audience. General appeal is used where a segment or particular population is desired to be reached. However, as to more specific marketing, such as within segments of target groups, the cost increases in order to personalize or customize the content of the material. Often, groups or segments of a population are selected to market to because that group or segment contains a specific population of individuals who generally share a common trait, characteristic or interest with other individuals of the group. A particularized appeal based on a common trait enables a marketing message directed to that commonality to reach those in the group. However, though persons may be classified into groups, not everyone considered to be part of a group will react in the same manner. Within a group, there often are subgroups or subsets, and within these subsets are individuals. Reaching individuals with known methods is costly, and requires preparation for each individual of the group.

For example, there are instances where the group may include applicants and prospective applicants to colleges (i.e., prospects). The prospects are desirous of obtaining information for particular colleges. In order to obtain information, these individual prospects may be presented with materials at college fairs, or at their schools, or may receive visits from personnel of a particular college. Most colleges have web sites which offer an overview of information, which may include statistics, departmental information, applications, as well as resources, such as library and databases. There may even be applicant/prospective applicant sections of a web site, with pages directed to information likely to be desired by an applicant. The web site may include information not pertinent to some applicants, but pertinent to other applicants. An applicant therefore must sort through non pertinent information in order to find relevant information. This may be time consuming, and depending on which information is first encountered, may lead an applicant or prospect to move off of the site and become disinterested. Some web sites have developed customization so that the user may have displayed certain information when the user visits the site, such as the local weather, or sports information, or a combination of these. However, these web sites also have general appeal.

A need exists to provide an improved apparatus and method so that a brand or sponsor may convey information that an individual desires where many individuals having diverse interests, though part of a large general common group, may receive pertinent information relating to their respective individual interests, and where the brand or sponsor may be alerted when the individual is present on the system so that further communications with the individual may be generated.

### SUMMARY OF THE INVENTION

A method and apparatus for facilitating providing information to an individual using inquiry management. One embodiment provides a database of information which is associated to correspond with selections on a selection menu. A mechanism for input of user data is provided, and user input data may be categorized to correspond with one or more selection data items. Selection data items may be associated with content information which may be used to generate or form part of the image of a personal web page. For example, a web page may be configured for each individual prospect upon that prospect visiting a web site. The selection data may be obtained from user inputs. The method and apparatus manage the user inputs to generate responses which correspond with the user inputs.

The personal web page may be configured prior to, or during, the prospect visit to a web site or web page, through input and storage of a user data selection information, including through the use of an on-line form.

A personal web page may have its own address, for example, a personal uniform resource locator (PURL). A PURL may be provided for each unique user and may be used to identify that unique user, including the profile for that user.

The method and apparatus coordinate and associate multiple media distribution with personal web site visits. Media event generators, such as event or distribution engines, may generate communications such as, for example, email, personal web pages, printed material or epages and ecards. The media event generators may be associated with user selected content so that there is a correspondence with the user information or user profile and the media distributed to the user.

In one embodiment, the method and apparatus may provide a search engine which may be used by a client in order to generate the interest of prospects. The prospects have the ability to generate results from the search engine, and the search engine is configured to retrieve associated results from client data. The search engine may display the results in a web page, which may be linked with a PURL associated with a particular individual. A single PURL may be provided for each prospect. The search engine may also be coupled with a connection linkage which facilitates association of results from the search engine retrieval process. The PURL information may include or be associated with the individual information, and individual information may be associated with one or more data sets which the search engine is configured to retrieve. The search engine retrieval may be configured to correspond with a media distribution. The media distribution engine may be configured to generate media events for communication to one or more individuals based on the search engine response, or the PURL activity. The media events may comprise electronic media, print media, telephone or voice media or combinations of them. The media distribution engine may be linked with media distribution data which may over a period of time, be modified, or be preset to change.

The media distribution engine also may be used in conjunction with, or include, an advertising engine. The advertising engine may be linked to advertising data which can be populated with one or more advertisements or sets of advertisements, which may over a period of time, change, or be preset to change. The advertising content may be linked or indexed to correspond with selected areas of interest of a user to more precisely correlate advertising content with a recipient.

One embodiment provides media elements to be generated while an individual, such as a user of the method or apparatus, is accessing a web page associated with the user's PURL. The PURL may be linked to generate a web page populated with information that the user desires, and may be updated with current data so that subsequent accesses of a web page by a user using that user's PURL may provide further information. The PURL associated web page may be populated with information about the sponsor, including the sponsor's activities, and the media distribution engine may populate a web page and may also generate one or more additional media events directing one or more media elements to the user. The one or more additional events may comprise reinforcement communications corresponding with the content displayed on the personalized web page associated with the PURL, or may comprise complementary information, details of activities and/or events. The media distribution engine when linked with, or including, an advertising engine may distribute advertising regarding related or associated goods or services (or may even relate to competitive goods or services).

### BRIEF DESCRIPTION OF THE DRAWING FIGURES

FIG. 1 is a schematic diagram illustrating an embodiment of the invention.

FIG. 2 is an example of an on-line web form page showing a user inquiry screen.

### DETAILED DESCRIPTION OF THE PREFERRED EMBODIMENTS

A method and apparatus for marketing information to an individual from a brand or communicator where personalized content is generated and provided to an individual based on individual preferences. According to one embodiment, the method and apparatus provide information to an individual which is selected to correspond with one or more interests of the individual. The method and apparatus provide communications which contain information in the form of text and graphics (for example copy and images) which may be accessed and viewed by an individual. The communicator may be a particular entity, which may be referred to herein as a brand or sponsor. The individual may be a potential consumer of the brand or sponsor, such as, for example, a prospective applicant who is interested in attending a university (e.g., the university constituting a brand or sponsor). The communicator, such as, for example, a university, may be able to meet the requirements, needs or qualifications that the individual is seeking. For example a prospective applicant may be interested in the sports program, and more specifically to a particular sport, such as, for example, lacrosse.

In the example where the communicator is a university, the prospect may already know of the university, or the university may undertake initializing activity to generate familiarity with it to a potential applicant. This may be done in any number of traditional ways, including direct mailings, in person meetings at a school attended by the prospective applicant, at a college fair, by a web page or general advertising through radio, television and newspapers, to mention some examples. Though the promotion of a general identity of a university may be served through general advertisements, prospective applicants generally seek out further more particularized and personalized information. In order to provide a level of personalized information desired, heretofore, this has previously involved undertakings by the individual which require the individual to sort through an abundance of information, including non-pertinent information. The method and apparatus provide information which the individual may access based on what that individual identifies as its interests. In addition, the method and apparatus may be used to analyze information inputs from an individual to more particularly facilitate concentration of information for the needs of the individual.

According to one embodiment, the communicator may establish an electronic display, such as, for example, a web site which may be accessed by individuals. The communicator utilizes on or in connection with the web site an electronically linked collection mechanism such as a web site input area or on-line web form to receive information from an individual. Alternately, or in addition, examples of ways in which the brand or communicator (the sponsor) may facilitate user visits to the sponsor web site in order to have the user input user selections are through the methods disclosed in my copending U.S. patent application Ser. No. 11/389,886 filed on Mar. 27, 2006 for an invention entitled “Method and Apparatus for Marketing a Brand”.

The individual user is assigned a unique identification element. The unique identification element may be a name provided by the individual which may also be linked or associated with a string of characters, symbols or a combination thereof. The name provided by the individual may be used to associate that individual with user information which may be contained in a data set. According to an embodiment, a personal uniform resource locator, referred to as a PURL, is based on a unique identification element, and may be generated to itself comprise the unique identification element. According to another embodiment, a PURL may contain an HTTP address having, as part of the address, a unique identification element. A user who inputs an email address, physical address, name, or other indicia, may have a PURL generated. The unique identifier is communicated to a user through a communication, which may be an electronic communication such as an email. The email may contain the user PURL, and may have that PURL actively linked to a script which opens a browser program on a user's computer to access the personalized web page associated with the user's PURL. The user may save the user PURL, for example, in a browser favorites file, or other file, so that the user may access the personalized web page associated with the browser.

An example of a PURL is http://www.mybullseye.net/bedemo/4DC7Bill. In this example, a web site is operated by a sponsor, which is a university, the university being Cabrini University. The university operates a web site having numerous web pages, which may be accessed at an address of: http://www.cabrini.edu. The content of the web pages is stored on storage means, such as a hard drive of a first server. Alternately a separate storage component may be used and linked with the server. Content data is also stored on a server linked with the address of the personal web site pages, www.mybullseye.net, and more particularly, in association with the PURL http://www.mybullseye.net/bedemo/4DC7Bill. According to one embodiment, a server, which may be a second server, generates a web page corresponding with the PURL. For example, where a user has identified particular interests, content pertaining to those interest categories and subcategories may be displayed on the personalized web site associated with the PURL. The personal web site may contain web pages, including pages which may display dynamic data.

The selections of the user are used to provide a personalized web page with content of the brand or sponsor that relates to the specific interests of the user. For example, where the sponsor is a university, an individual may identify one or more areas of interest from categories or subjects offered by the university, such as, for example, mathematics, clubs and social activities, athletics, or management. There also may be subcategories associated with categories of interest, such as, for example, management business information systems or hospitality management.

The content associated with a user's PURL may be updated or modified by the user, such as, for example, by the user changing or adding user selections, or by the university, which may provide updated or alternate content. The content which is used to constitute the web pages associated with the PURL may be updated from time to time, so that the user may access the user's personalized web site through the PURL and have current or alternate information available to the user, including new additions or updates provided by the brand.

The user profile includes information pertaining to that user. Information is collected about a user. A user's interests may be identified by inputs which the user selects or provides. The user information which is stored to correspond with a particular user includes selection data which the user associates with that user through one or more selections made by the user. According to another embodiment, alternately, one may make selections on the user's behalf so that user selections represented by the user selection data are based on the user's selections, although they may be input by another. The user selection data may include a combination of user inputs and inputs by another, such as the sponsor, on the user's behalf. For example, a user may be part of a group which has expressed interest in a particular course of study, perhaps business information systems management. A PURL may be generated for that user by a sponsor or other party based on the selected interest in the course of study. This may be done using email, print or other communications to alert the user that a PURL exists for that user. The methods and apparatus discussed in my copending application Ser. No. 11/389,886, referred to above, may be applied to generate the PURL communication to a user.

According to one embodiment, a web application server is provided and may be used for generating input communication, such as an on-line web form. The on-line web form is accessible through a communications link. For example, a user may access the on-line web form through the Internet using a suitable connection device, such as for example a personal computer, PDA or phone. The user may input one or more selections from the menu of an on-line form. The user selections are stored as user selection data and the data collected with the on-line form is stored on a data storage means. The data storage means for storing the user selection data may be stored on the web application server or any other storage device linked with the server so communication of user selection data may be transferred to the storage device.

The method and apparatus generate a personalized uniform resource locator (PURL) which corresponds with a unique user and is associated with that user's data including user selection data. A first interactive display is generated and may be provided as a personalized web page which is viewable by that individual through an electronics communication device which is linked to access content from a web production server. The web production server is programmed with software for generating a web page having content based on associations between user data selections (which are stored as user selection data) and web content information. The web content information may be stored on the web application server, or a storage device linked with the web application server so that it may be accessible by the web application server. The user selection data is processed with a processor which may be performed at the web application server, or another server linked therewith, to control the types of information which generates for display on a user's personalized web page. For example, where the individual is John Smith who is seeking universities that have a lacrosse program, and that information has been input at the user selection interface (such as the on-line form), the web content information may include information relating to lacrosse programs of the university which may be generated for display on the personal web page linked with the user's PURL.

User information includes one or more addresses where the user may receive information, including for example, electronic or printed material. For example, the address may correspond to an email address of an email account through which the user may receive email communications. Alternately, or additionally, the address may correspond to a physical location or postal address where printed material (e.g., mail) may be delivered to the user. One or more additional addresses also may be included, so for example, a user's parents or friend may receive materials or communications, or the user may receive them at one or more addresses.

According to one embodiment, the apparatus and method provide an email creation and transport server which is linked with or able to access the user data. The user data contains information which corresponds with stored content data of the email creation and transport server. The email server may have or be associated with a storage component on which email content data is stored. For example, email content data stored on a storage means for access by said email creation and transport server may include information regarding the sponsor's programs or products, as well as marketing and advertising information. The email content data may be stored or changed periodically, and may be associated with one or more categories. The email content data may be used for generating email text, graphics and ecards for communication from the creation and transport server to a user address. User data associated with a PURL may contain one or more user email addresses to which the email creation and transport server may send and/or forward information. The email content may be generated based on user selection data, including user selection data collected from a prior visit to a web site, or even as the user is accessing the web site of the communicator or sponsor. For example, a user may input selections and have associated with user input data a PURL. A user web page may be generated and associated with the user PURL. User activity may be relayed to the sponsor, communicator or site owner, including at the time when the user is actively accessing the site. Optionally, or additionally, user activity may also be linked with an advertising engine. For example, where a user selects English as an interest or major, an advertisement with associated content may be generated to appear on the user's personalized web site associated with the user PURL. A banner, window, or other form of indicia may be generated to appear on the user's personalized web site. The user selecting English as an interest or major, for example, may be presented with an advertisement featuring a national book store chain. Further communications from the sponsor, or by another, such as a primary marketer, on behalf of the sponsor, based on the user's PURL activity or on media distribution associated with that activity may be linked with or indexed with an advertising engine. According to one embodiment, an advertising engine may be programmed to distribute advertising content in the form of media communications to a user. The advertising may be co-advertising with the sponsor brand, or may be independent. For example, user activity may be monitored, and advertising generated based on the user activity, including based on actual or stored user data, such as, for example, events, inputs and selections. The user activity may be stored as activity data. Activity data may be stored for a single user, as well as categorically for a number of users. For example, the number of users for whom a PURL was generated may be tracked, as well as the number of users who responded to an email containing a PURL by accessing a personal web site using the PURL. Other user selections may be tracked and stored. For example, where a university has a particular number of departments, and finds that one department, for example, mathematics, is having a low percentage of interest relative to the other departments, then that data may be used for management and decision making, including, for example, budgetary and hiring/staffing matters.

A reporting engine may be provided and may be operated using software programmed to report the data pertaining to user access and selections. The reporting engine may provide data which is capable of being reviewed to evaluate the effectiveness of any accesses or processes. The reporting engine may be linked with an analysis engine. An analysis engine may include software programmed to analyze the data collected and reported with the reporting engine. The analysis engine may be programmed to recognize particular patterns or events associated with the data. For example, a heightened relative level of interest in social activities based on user data input selections may be ascertained through the analysis of the reported data. The analysis may provide evaluation of the data and interpretations of the data.

According to another embodiment, the reporting engine may include a facility to export data collected from a user, such as, for example, user selection data, including, for example, user accesses of the user PURL, user generated emails/correspondence, communications sent to the user, and content associated with the user PURL. The data may be exported to the sponsor for further processing and analysis by the sponsor to facilitate the sponsor's service operations, such as customer service, management operations/solutions or marketing. The data export engine may be programmed to communicate the data to the sponsor. The sponsor may use the raw data, or the data may be formatted as desired for presentation in a generated or formatted report.

Active management of user selection data may be accomplished through the use of the reporting and analysis features. The analysis engine may provide the patterns or events detected, and content may be managed based on the analysis results. For example, where the university notices a decline in an interest in mathematics related user data selections, the management system may be programmed to provide a hierarchy of content listing. This may be used in connection with the personalized web page content generation. For example, even where a user selects an interest in mathematics, where the management system determines math is lower in interest rating relative to other user selections, that interest is not placed in the prominent location on the user's personalized web page. For example, the management process according to the invention may detect particular interests, such as, for example, user selection data in faculty for the business department. The management system may be able to use the event information provided by the analysis engine to draw into the topic associated with the business department additional information, such as for example, a faculty data set, so that the faculty data set is linked loaded with, or otherwise readily available to as user when the user accesses the user's personalized web page associated with the user's PURL. The management system also may be used for managing activities at the university end, including hiring, personnel and budgetary matters.

According to another embodiment, the university may program the management system to carry out operations on the main web site of the university in response to analysis data generated with the analysis engine. This may, for example, constitute changing the main greeting or image on the home or primary access page to correlate with the user selection data events or patterns which may signify a particular interest or lack of interest. One pattern may be selections made at a particular time of the day when the user accesses the personalized web page. In this manner, the apparatus may facilitate content pertinence through the use of selection data corresponding with interests of users who are potential applicants for the university. The management system may be used to manage other aspects where data from user selections is desired to be used to direct content or communications.

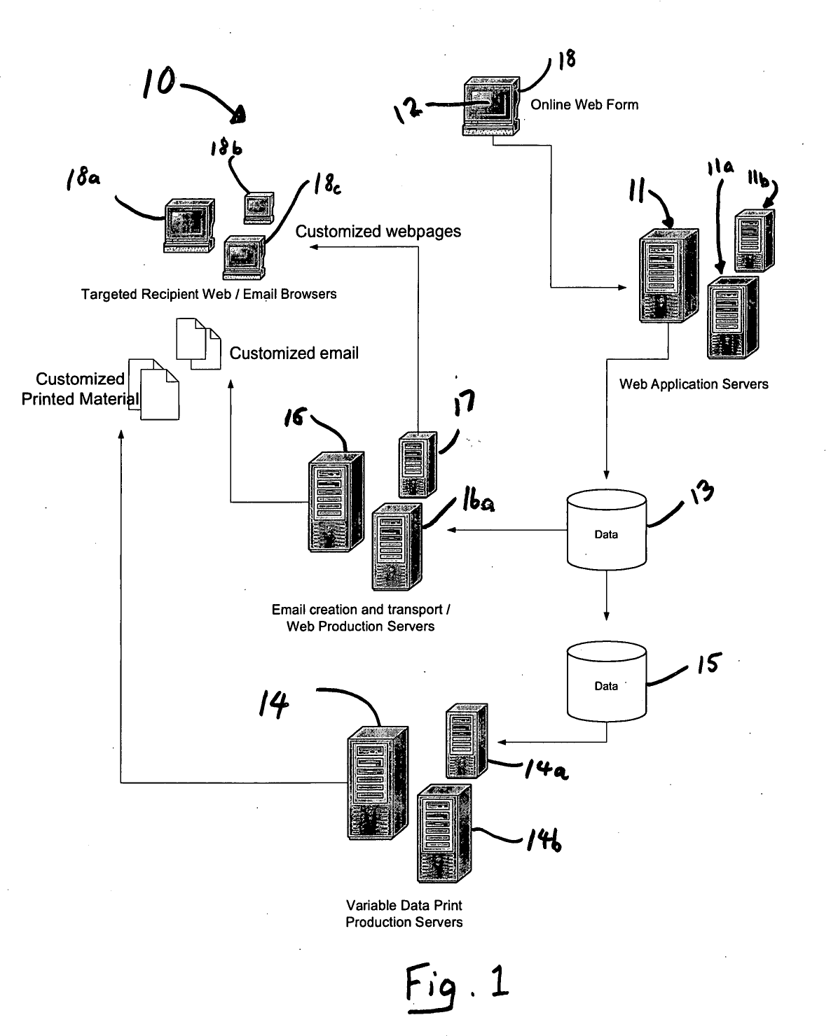

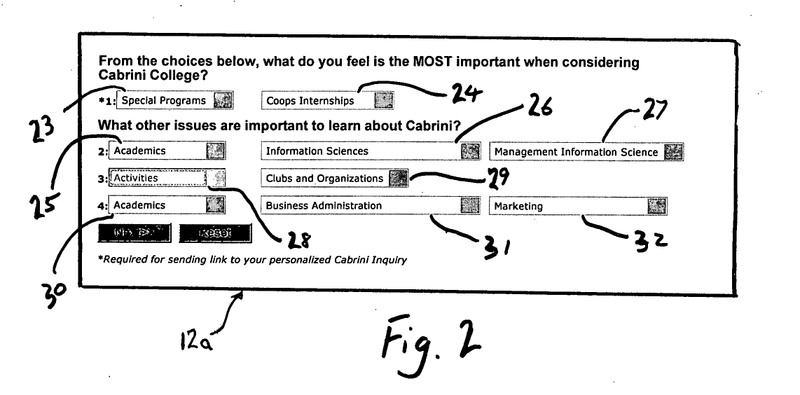

Referring to FIG. 1, there is illustrated an embodiment exemplifying in a schematic form an apparatus 10 and method for marketing information to an individual from a brand or communicator where personalized content is generated and provided to an individual based on individual preferences. FIG. 1 shows a web application server 11, also referred to as a web server. There may be one or more web application servers 11a, 11b provided, and, optionally or alternately, the web application servers 11, 11a, 11b may be linked for communication with each other. Though described with a single web server 11, additional servers, such as those 11a, 11b, may be used. The web application server 11, or web server, may be preprogrammed with software capable of generating an on-line form 12. The on-line form 12, which is schematically represented, may contain data input fields, such as boxes for the user input of the user's name and addresses (email address, postal mail address). The on-line form 12 may be accessed by a user through the user's computer 18. The data input fields may be selections from one or more choices. For example, interests may appear as a selection of several, in a drop down menu, list, or other presentation. Alternately, or in addition thereto, the selections may be included in content of a database or index which is searchable. The information may be a single page form, or may be presented in multiple pages, or a scrolling page. FIG. 2 illustrates an example of a multiple page on-line form, showing a page 12a where user selection data may be input through the use of preferences which may be selected in drop down menus. The page 12a illustrated in FIG. 2 may be generated for display when a user inputs information sufficient to generate a unique user identification. The selections in the selection boxes 23, 24, 25, 26, 27, 28, 29, 30, 31 and 32, represent choices selected from those of the drop down menus (every choice not being shown).

The on-line form 12 is programmed and configured to provide the ability for a user to select one or more selections. The user selections are stored as the user selection data, which includes the user's unique identifier or PURL, which may be based on an email address, name, number or combination thereof which corresponds with user input identifying the user. The user identification data may be processed and the user unique identifier configured to comprise the data input in the form by the user, or a number or form, tagged to uniquely correspond with that user selection data file. This unique identification may be includes as part of the user PURL. For example, a user unique identifying data element may include a user's email address The on-line form 12 is configured to be generated for a user who seeks more information. The inputs may be revised, as desired by a user by the user visiting the user's personalized web site through the PURL. The revisions may be made in the manner as they were initially made, again, using an on-line form. According to one embodiment, the on-line form of FIG. 2 may also illustrate the revision form on which may be presented to the user the currently selected preferences, and which provides the user with the opportunity to change or delete those selections.

The web application server 11 which is used to generate the on-line form 12 may be separate from the server on which the form link is contained. For example, a sponsor may present a link on the sponsor's web site. According to one embodiment, that sponsor's web site may be generated by a sponsor server (not shown) which may be used, licensed or otherwise maintained for hosting the sponsor's web site, and the web application server 11 used to generate the on-line form 12, may constitute another server which may be accessed through a link or communications means to the site server. For example, according to one embodiment, the on-line form 12 is generated by the web site server. According to another embodiment, the on-line form 12 is generated by a server other than the server generating the sponsor web site. A third party may administer the web application server 11. The third party may, for example, be a primary marketer for a sponsor or communicator. A link may be present on the web site pages of the sponsor which is associated with a button, icon, or other indicia appearing on the sponsor's web site. The link may be activated by the user selecting the button, icon, or indicia for the information request. A web page may generate from the web application server 11. The user may or may not even be aware that the alternate web application server 11 is providing the on-line web form 12. The form 12 may be configured and designed to appear consistent with the sponsor web site, or may have a modified or different design. In other words, the PURL personalized web site may be seamlessly integrated with the sponsor's web site, which may be accomplished through a seamless redirection from the sponsor's web site to the PURL site.

According to an alternate embodiment, other means may be used for generating a user profile. For example, an on-line form may be prepared by an individual or organization, such as a school counselor, on behalf of a user. Alternately, the school counselor may forward information regarding students and respective student interests to a sponsor, and the sponsor, or third party provider, such as a primary marketer, may enter the information into the user selection data files, including using an on-line form.

The web application server 11 has or is linked to a data storage component 13, such as, for example, a hard drive, for storing user selection data associated with an individual which is received through inputs and selections, including those entered on an on-line web form 12. The data storage component 13 may be a hard drive of a computer, linkable drive or the hard drive of a web application server 11, or of the sponsor web site server.

The embodiment of the apparatus illustrated in FIG. 1 is shown having one or more print production servers 14, 14a, 14b, which contains a print production engine. The print production engine may include software programmed to produce printed material based on a designated data set. The print content data may be stored in a data storage component 15 such as, for example, a hard drive which may be accessed by the print production server 14, 14a, 14b. For example, user selection data may be used to designate the printed material that is to be distributed to an individual user. The printed material may be generated based on interests indicated by the user, and may be generated in conjunction with user visits to the users personalized web page, including to correspond with user accesses of a user's PURL. The printed material may include material that the sponsor regularly distributes, or may be generated as personalized printed material which is personalized based on user selection data.

FIG. 1 illustrates email creation and transport servers 16, 16a that include an email engine. One or more email creation and transport servers 16, 16a may be used. The email engine may include software programmed to generate email communications to a user based on the user selection data. The email may be personalized email directed to the user, and may address the user's interests. The email engine may be linked to receive inputs from the web application server 11 so that when a user unique identifier or PURL is generated, the web application server 11 provides that information to the email server 16. For example, if the user data contains an email address (and the inputs may be programmed to require one in order to generate a unique identifier), an initial email may be sent to a user which contains information about the user personalized web page, which may, for example, include a link (such as an active link/hyperlink) which is the user's PURL. From the email containing the PURL, it is possible for a user to cut and paste the PURL or activate by clicking the PURL (if the link is active) in order to access the personal web page associated with the user PURL. The email engine may also be programmed to generate and distribute email to a user based on events. For example, each time-a user activates the user's PURL or visits the personalized web site (associated with the PURL) the web application server may report that to the email server, and the email engine may be programmed to generate personalized email and send it to the user. The email creation and transport server 16 may be linked to email content data which may be stored on a data storage means, such as a storage component 13, 15, which may be a hard drive or other storage media. The email correspondence generated may be a personalized communication to a user prepared using stored content data, which may be included in the email to be sent to a user. The email content may include pictures, logos, text, and other pertinent matter. For example, the email content data may be updated so that, for example, where a user has a particular interest in a sports activity, the updated scores or schedule for the team or activity may be included in the email. Another example is where the user has expressed an interest in the business information systems department, the updated information may include symposium information dates and/or invitations to visit particular departments (e.g., open houses) which the user may find to be of interest. The ability to update the email content data, so that current information is available for distribution facilitates the ability to avoid stale information being regenerated.

The email engine may also be programmed to keep track of email content already sent, so that when additional emails are sent to a user, the email content is different. This may, for example, include providing a different message text, different images, content, or one or more of these. Email content data may be indexed or tagged to user data to control duplication of content.

A web production server 17 may be used in conjunction with, or as, the email creation and transport server 16. In the example illustrated in FIG. 1, the email creation and transport server 16 is shown separate from the web production server 17, though alternately, they may be provided together in the same hardware unit. According to one embodiment, the web production server 17 may be separately provided and linked with the other servers or components of the apparatus. The web production server 17 is programmed to generate web page content based on user selection data. The web page content may be stored in a storage means. For example, web content data may be stored on a storage component, such as, for example, the hard drive 13 shown in FIG. 1, so that it may be accessed by the web production server 17. Alternately, the web production server 17 or email server 16 may itself have storage means. The web content data may include content from which a user's personalized web page associated with the user PURL may be generated. The web production server 17 may contain a web page engine. The web page engine may include software programmed to generate a web page based on the user selection data associated with a user's PURL. The web page engine may generate a personalized web page for each PURL, where the personalized web page contains content associated to correspond with the user selection data for the unique user associated with the PURL that is linked with the web page. The user may use a personal computer 18a, 18b, 18c to view the personalized web pages associated with the PURL. Though a personal computer 18 is illustrated linked with the web application server 11, the web production server 16, 16a may be accessed using the same computer 18.

Optionally, the selections of the user on the site may be stored, streamed or otherwise communicated to a media distribution engine. The media distribution engine may comprise software programmed to generate media events, including printed or electronic communications in response to user selection data, active user selection data, or both. The media distribution engine may include or be linked with an advertising engine. The advertising engine may include software which is programmed to generate media events when a user is actively visiting a web site associated with the user PURL. For example, the media events may comprise sending an email or mailing printed material. The information included in the email or printed material may relate to the user selections, or may be complementary or associated with the selection. The media event generation facilitates the sponsor's marketing efforts to provide further information to a user.

One or more secondary or associated advertising engines may be linked or connected with a media distribution engine or primary advertising engine to facilitate marketing of information from persons other than the sponsor. For example, the sponsor may have affiliations and the affiliates may generate media events based on user data which the sponsor may choose to share with an affiliate. The user of the term affiliate may be used to mean any person other than the sponsor, or a sub-group within the sponsor organization, which may use the user data including user-input selections to correlate marketing information with that user. For example, in the case of a prospective student considering a university, when the student selects an input relating to visiting the university, a primary or secondary advertising engine may process that selection to generate a media event which may contain information about a hotel nearby which may be of interest to the user. General information may also be used. For example, where user data corresponds with an interest or activity represented by an advertising category, a media event containing advertising content may be generated.

Another example of advertising association or linkage to user selection data includes where the advertising content is based on one or more user selection data elements. For example, where one user selection data element is an address element, such as the zip code of the user mailing address, and another user selection data element is user selection of a baseball interest, then when the user selects the baseball interest an advertisement for a brand of baseball equipment, such as spikes, may be generated on the personalized web page being viewed by the user (the user's PURL site). Advertisements for baseball tickets to a local event may also appear. In addition to local advertisements, national advertisements may be linked or indexed with one or more data elements of user selection data. For example, a coupon for a national sports store chain may generate an invitation to the store's site. Alternately, the advertisement may be generated by the sponsor for example, to purchase sports jerseys of the sponsor's brand. The advertising engine may be programmed to deliver content related advertising from parties other than the sponsor (e.g., third parties) through a variety of media including, for example, email, ecards, printed material, and the like. The advertising data or content may be changed, including being programmed to change content (or distribution) over a particular frequency. An advertising engine may include software programmed to associate advertising content with one or more data elements of user selection data corresponding with a user's PURL. Advertising content data may be separately stored in a data base or file, and indexed or linked for retrieval by the advertising engine based on a user's profile as represented by the user selection data.

According to an embodiment of the invention, the information from which an interactive electronic display is generated may be selected from content of an existing web site of a brand or sponsor. The existing content may be categorized and stored in a separate server for access by a user, where the separate server is programmed to associate and display content from categories associated with a user's PURL. Another embodiment provides information which may not be identical to the content of the brand web site, but may be very similar, or more specifically directed to one or more of the selected or associated categories by including different, such as more detailed or more abundant, information.

Once a PURL is established for a user, upon entry of that unique identifier or PURL, a resource is located. According to one embodiment, the method may use a communications link with a web production server to generate a web page template which includes content objects associated with the unique identifier. A user may access and view information generated through an electronic display with electronic display means. An electronic display means facilitates the displaying of the information which is associated with the user PURL for viewing by a user. The electronic display means may comprise a monitor or screen which is capable of displaying an output from a computer, web server, communications linkage, or other processor or device which may generate the web pages associated with the PURL. For example, an LCD, plasma, CRT or other suitable device may be used for displaying the information. The electronic display screen is preferably used in connection with a processing device, such as a computer.

A user may use a personal computer to access and view the information, including an on-line web form 12 and web pages associated with the user's PURL. The user's personalized web site appearing on the electronic display means may comprise a predefined template which can be configured for the particular user who is accessing it. For example, one template may be used to generate with information such as the university logo, address, and content objects which are programmed to generate with the template, where the content objects include content objects corresponding to user selection data. An individual may be matched with the brand or sponsor which is seeking to promote its identity, resources, and/or capabilities to the individual. For example, the brand or sponsor may desire to communicate different information to different individuals, as needed. An individual may provide input information or criteria which may be used to comprise a prospect data set. The information provided by an individual may be requested or designated by the brand or sponsor. One embodiment provides a drop down menu on an electronic display means, such as a web page generated by the brand or sponsor. The drop down menu may comprise one or more boxes with selections which the user may affirm or reject. For example, according to one example, where the user is a prospective college applicant, the user may be interested in ascertaining information about the university that may be under consideration, or that the user may want to explore further. The university may comprise the brand or sponsor. For example, ICD University (ICDU) may have material which it provides to prospective applicants. The material may be what some prospects may request or may be seeking. According to one example, material may be contained within the sponsor's web site, but not readily apparent to the user. According to other embodiments, the material may exist, but not be contained on the sponsor's web site, or alternately, certain information (such as images or objects to mention some examples) may be contained on the sponsor's web site which is also used in the PURL associated personalized web pages. The apparatus and method facilitate making the material available to the user so that the user is presented with the material without having to sift through numerous menu selections or material which is not pertinent, useful or of interest to that user.

According to another embodiment, the method and apparatus may provide a search engine which may be used by a client or sponsor for prospects. The prospects have the ability to generate results from the search engine, and the search engine is configured to retrieve associated results from client data. The search engine may display the results in a web page, which may be a PURL associated with a particular individual. A single PURL may be provided for each prospect. The search engine may also be coupled with a connection linkage which facilitates association of results from the search engine retrieval process. The PURL information, which may include the individual information, and individual contact information may be associated with one or more data sets which the search engine is configured to retrieve. The search engine retrieval may be configured to correspond with an advertising engine. The advertising engine may be configured to generate media events for communication to one or more individuals based on the search engine response, or the PURL activity. The media events may comprise electronic media, print media, telephone or voice media or combinations of them. The advertising engine may be linked to advertising data which may be populated with one or more advertisements or sets of advertisements, which may over a period of time, change, or be preset to change.

One embodiment provides advertisements to be generated while an individual or user is accessing a web page associated with the users PURL. The PURL may be populated with information that the user desires, and may be updated with current data so that subsequent accesses of a web page associated with a PURL may provide different information. The PURL may be populated with advertisements, and the ad engine may populate a web page and may also generate one or more additional media events directing advertising to the user. The one or more additional events may comprise reinforcement advertising corresponding with the advertising displayed on the page associated with the PURL, or may comprise complementary advertising (of related or associated goods or services) or may comprise competitive goods or services.

According to another embodiment, a third party, such as a guidance counselor of a school or other representative, may be provided with a unique identifier, such as, for example, a user PURL from which students may be assigned a user PURL which also contains the guidance counselor PURL (or an identifying component thereof). The guidance counselor may use the guidance counselor PURL to facilitate communications between the sponsor, or university, in this example, and the user or student (prospective applicant). For example, the guidance counselor, in part or entirely, may determine which information, template and/or content objects, including for example, which set of images, may be displayed for each student (prospect) PURL. This may be done similarly for a particular group of users (such as for example, a subgroup). The sponsor, or university in this example, may establish a template or control all, or part of, what the guidance counselor may communicate through the personalized web pages. For example, the guidance counselor may pass information to the sponsor, and the sponsor may respond by causing information to associate and appear on the user web site associated with the PURL. The sponsor or university may guide or limit the guidance counselor's ability to respond to student requests, for example, by providing a data set containing prepared responses from which the guidance counselor may select, depending on the applicant communication or inquiry.

Each applicant preferably may be associated with a template. This association may be done by the university or a guidance counselor. The applicant contact database may include means for linking each applicant with one or more data records of the data set or template database. Content may be associated with one or more data sets so that applicants applying from one school may be associated with a particular data set or part of a particular data item of a data set.

The template and content objects may display the university designated content as well as guidance counselor selected or generated content in the form of a personalized web page. The personalized web page may be generated from the data stored and collected in association with the unique identification element. When the applicant user utilizes a communications link to view the display images associated with or generated by the data sets, the applicant user is presented with a personalized set of information, which preferably is displayed in a personal web page. The guidance counselor, as well as the university, may use the information collected and generated to ascertain applicant preferences. For example, the university may ascertain when, and how often, applicants view the personalized web pages. The university may also consider the guidance counselor responses and inquiries, in order to determine whether a particular inquiry is occurring, and over what particular frequency, so that the university may address it. The university may receive evaluation data relating to whether a particular offering or interest is effective for the purposes desired by the university. For example, the university may record quantitatively, or qualitatively, whether applicants are interested in a particular discipline, academic area, social areas, or other university activity. Another feature is the ability to provide immediate notification to the sponsor or the representative (such as the guidance counselor) based on the user's requests or accesses of the PURL.

The user may also make on demand requests for material to be communicated to the user through print or email correspondence. The sponsor or representative may be notified of the user requests when they are made. Though FIG. 2 illustrates a type of on-line form 12, the on-line form content may be customized as desired.

Examples illustrating embodiments of the invention are discussed herein, but are not intended to be limiting. The sponsor, discussed as an educations institution, e.g., a university, in one or more examples herein, may be a brand or other communicator desiring to promote interest in its events, activities or products. Other examples of sponsors or communicators may include automobile/boat dealerships, financial services companies, government agencies, healthcare organizations, manufacturing companies, and pharmaceutical and medical device entities. In addition, though embodiments illustrate an on-line form for collection of user input data which may be used for user selection data, a sponsor, or one on the sponsor's behalf, may provide user profile data which may be used to generate user selection data. For example, existing data stores may be used to match one or more users. In addition, though storage devices are shown and described in connection with the illustrations and examples referred to, the storage devices may comprise hard drives of a personal computer, server, or other suitable storage media, such as, for example, a network drive unit. A web page engine may include software which may be used for generating web pages. The web application server may be operated using software, such as commercially available software programs. For example, the personalized web pages may be generated through the use of commercially available multi-media variable data publishing software, including XMPie PersonalEffect or PageFlex Mpower, or other like suitable software. According to embodiments of the invention, the connection and association of content objects with templates may be facilitated by utilizing multi-media variable data publishing software. The web pages may be created and then published to a web server, such as for example, the web production server or web application server described herein. A PURL is associated with data which may be used to form a web page, including, for example, one or more content objects which may be used to comprise the web site pages on an electronic display means, such as a computer monitor. Content objects may be stored on a data storage means, and may be associated with a template. For example, if the user selection data contains data that relates to or matches a particular content object or particular metric, then a particular template may be used to comprise one or more web pages associated with the PURL, as well as particular content objects associated with the data set. According to another embodiment, there is provided a database of information which is associated to correspond with selections on a selection menu. A means for input of user data is provided, and user input data may be categorized to correspond with one or more selection data items. Selection data items may be associated with information which may be used to generate or form part of the image of a personal web page. For example, a personalized web page may be configured for each individual prospect upon that prospect visiting a web site. The personalized web page may be configured prior to the prospect visit, through input of user selection data information. A personalized web page may have its own address, for example, a personal uniform resource locator (PURL). Embodiments shown and described herein may coordinate and associate multiple media with personal web site visits. According to embodiments, printed material may be created using multi-media variable data publishing software. A template may be created using commercially available software, such as, for example, desktop publishing software (e.g., Adobe Indesign, Quark Xpress, or the like). A print file may be created, and the print file may be stored and/or processed for printing. A high speed printer may be used to generate the printed material, such as, for example, a high speed full color digital printer, including those sold under the brands KODAK® Nexpress or XEROX® iGen3.

While the invention has been described with reference to specific embodiments, the description is illustrative and is not to be construed as limiting the scope of the invention. Various modifications and changes may occur to those skilled in the art without departing from the spirit and scope of the invention described herein and as defined by the appended claims.

What is claimed is:

1. A method for marketing information to an individual from a communicator, comprising:
generating a unique identification element and associating that unique identification element with an individual user;
collecting user information about said individual user, wherein said user information comprises user selection data;
generating a first interactive electronic display for said individual which is viewable by said individual through an electronic communications means;
wherein said first interactive display is generated based on user selection data, said user selection data comprising data provided by said user;
said user information further comprising one or more addresses associated with said user whereby said user may receive printed or electronic communications;
establishing a personalized uniform resource locator (PURL) for a user and associating said user PURL with content to be displayed on said first interactive electronic display, wherein said PURL is based on said unique identification element; and
generating in response to said user accessing said user's personalized uniform resource locator (PURL), one or more printed or electronic communications for said user that is associated with the subject matter of said user.

2. The method of claim 1, wherein said user selection data includes inputs provided by said user.

3. The method of claim 2, wherein said inputs are collected through an on-line web form.

4. The method of claim 3, wherein the user is a student, and wherein a guidance counselor enters the inputs for the student, and wherein said PURL generated for said student user includes a second unique identification element associated with the guidance counselor.

5. The method of claim 1, including alerting said communicator that said user is accessing said PURL; monitoring said user access of said web pages associated with said PURL for user activity; and generating a responsive media event associated with said user selection data.

6. The method of claim 5, wherein the media event consists of one or more of an e-mail communication, instant message, or printed mail directed to said user at a respective email address, instant message id or postal mail address.

7. The method of claim 1, including generating an alert and communicating said alert to a media distribution engine when said user accesses said PURL; monitoring said user access of said web pages associated with said PURL for user activity; and generating a responsive media event associated with said user selection data.

8. The method of claim 1, including generating an alert and communicating said alert to an advertising engine when said user accesses said PURL; monitoring said user access of said web pages associated with said PURL for user activity; and generating a responsive advertisement associated with said user selection data.

9. The method of claim 1, including determining a target group, assigning said user to a target group; preparing and storing on a periodic frequency, media content wherein said media content is associated with one or more target groups; changing said media content at a frequency to update, amend or replace said media content; and wherein said media content includes a first media component which is generated in response to said user accessing said user's personalized uniform resource locator (PURL) and which is displayed on said web page, and a second media component which comprises one or more printed or electronic communications for said user that are associated with the subject matter of said user selection data, such that generating an event in response to content being delivered to a user PURL based on user selection data includes causing a content to display on said web page associated with said PURL, and causing distribution of related or associated content through a media event other than the web page.

10. The method of claim 9, wherein said first media content or said second media content are associated with different sponsors.

11. The method of claim 1, including determining a target group, assigning said user to a target group; preparing and storing on a periodic frequency, advertising indicia wherein said advertising indicia is associated with one or more target groups; changing said advertising indicia at a frequency to update, amend or replace said advertising indicia; and wherein said advertising indicia includes a first advertising component which is generated in response to said user accessing said user's personalized uniform resource locator (PURL) and which is displayed on said web page, and a second advertising component which comprises one or more printed or electronic communications for said user that are associated with the subject matter of said user selection data, such that generating an event in response to content being delivered to a user PURL based on user selection data includes causing an advertisement to display on said web page associated with said PURL, and causing distribution of advertising through a media event other than the web page.

12. The method of claim 8, wherein causing content to display on said web page associated with said PURL, and causing distribution of content through a media event other than the web page occur simultaneously.

13. The method of claim 8, wherein the communicator may control the distribution of content while the user is accessing said PURL.

14. The method of claim 7, wherein said media distribution engine may be linked to one or more advertising engines.

15. The method of claim 1, wherein said electronic display associated with a user PURL contains content categories, and wherein the method includes associating a media event with each content category and generating a said associated media event in response to said content category being accessed or updated.

16. An apparatus for facilitating marketing of information to an individual from a communicator, comprising:
at least one web application server;
an online web form capable of being generated by said web application server;
data storage means for storing user selection data associated with an individual which is received through inputs and selections on said online web form;
at least one print production server;
at least one email creation and transport server;
at least one web production server;
email data stored on a storage means for access by said email creation and transport server;
web content data stored on a storage means for access by said web production server;
wherein said email server contains an email engine which is programmed to generate email to a user based on said user selection data;
wherein said web production server contains a web page engine which is programmed to generate a web page based on said user selection data; wherein a personal uniform resource locator (PURL) is generated for each unique user, and wherein said web page engine is capable of generating a web page for each PURL which is based on user selection data for the unique user associated with said PURL; and
wherein said print production server contains a print production engine which is programmed to produce printed material based on said user selection data for distribution to said individual user.

17. An apparatus for facilitating marketing of information to an individual from a communicator, comprising:
means for generating and storing a unique identification element and associating that unique identification element with an individual user;
means for collecting information about said individual user;
data storage means for storing user information collected about said individual user, wherein said user information comprises said user selection data;
means for generating a first interactive electronic display for said individual which is viewable by said individual through an electronic communications means;
wherein said first interactive display is generated based on user selection data which comprises user data provided by said user in order to generate user selections to control types of information to be displayed on said first interactive electronic display;
said user information including one or more addresses associated with said user whereby said user may receive printed or electronic communications;
wherein a personal uniform resource locator (PURL) base on said unique identification element is provided for a user and is associated with said types of information to be displayed on said first interactive electronic display; and
an advertising engine which is programmed to generate one or more printed or electronic communications for said user that are associated with the subject matter of said user in response to said user accessing said user's personalized uniform resource locator (PURL).

18. The apparatus of claim 17, wherein the means for generating a first interactive electronic display for said individual comprises data storage means.

19. A method for facilitating communication of information to an individual user which is a prospect or applicant from a communicator which is an academic institution, comprising:
generating a unique identification element for the user in response to a user input and associating that unique identification element with the individual user;
providing an on-line web form which is accessible to a user through a communications link;
collecting with said on-line web form user information about said individual user including the user's areas of academic interest, wherein said user information comprises user selection data;
providing a web production server;
generating with said web production server a first interactive electronic display which comprises a personal web page for said individual which is viewable by said individual through an electronic communications means linked to access content generated from said web production server;
wherein said personal web page includes content generated based on user selection data, said user selection data comprising user data provided by said user in order to generate user selections to control types of information to be displayed on said personal web page;
wherein said user information further comprises one or more addresses associated with said user whereby said user may receive printed or electronic communications;
providing an email creation and transport server;
providing a print production server;
establishing a personal uniform resource locator (PURL) for a user and associating said user PURL with said types of information to be displayed on said personal web page; and
generating with said email creation and transport server and/or said print production server one or more personalized electronic communications for said user that is associated with the subject matter of said user when said user accesses said user's personalized uniform resource locator (PURL).

20. The method of claim 19, wherein said academic institution has a first web site which contains web pages and is hosted by a first server, and wherein said web production server and said email creation and transport server are operated by a third party, wherein said user PURL is associated with content for generation of said personalized web pages wherein said content is stored on data storage means remote from said first server.

21. The method of claim 19, wherein the first server comprises a server which hosts said academic institution's web site.

22. The method of claim 19, wherein the first server is operated by a party other than the academic institution.

23. The method of claim 20, wherein providing an on-line web form includes generating an on-line web form with a server operated by a third party.

24. The method of claim 7, wherein the media distribution engine includes an advertising engine which is programmed to deliver advertising content.

25. The method of claim 24, wherein the advertising engine is programmed to index advertising content with one or more elements of user selection data and generate advertising in the form of a media event.

26. The method of claim 25, wherein at least one element of user selection data comprises a user address element.

27. The method of claim 26, wherein at least one element of user selection data comprises a user interest element.

28. The apparatus of claim 17, wherein said advertising engine includes means for associating advertising with one or more data elements of user selection data corresponding with a PURL.
